(19) United States
(12) Patent Application Publication
(10) Pub. No.: US 2005/0044405 A1
(43) Pub. Date: Feb. 24, 2005

(54) System and method of securing a computer from unauthorized access

(76) Inventor: Lynn D. Spraggs, Vernon (CA)

Correspondence Address: ANTONY C. EDWARDS, SUITE 800 - 1708 DOLPHIN AVENUE, KELOWNA, BC, V1Y 9S4, CA

(21) Appl. No.: 10/950,387

(22) Filed: Sep. 28, 2004

Related U.S. Application Data
(63) Continuation-in-part of application No. 09/554,417, filed on May 11, 2000.

(51) Int. Cl. G06F 11/30

(52) U.S. Cl. 713/200; 713/182

(57) ABSTRACT

A web server computer that is secured from unauthorized access without requiring a firewall. The web server computer is secured from an authorized external client computer over the Internet by removing the web server's root or supervisor rights. The external client computer can be authorized through a trusted IP address list, as well as requiring a password key from the user of the external client computer. A telnet session and an ftp session can remain connected between the server computer and the Internet in order to manage the server computer while it is locked. Even though the supervisor rights have been removed from the server computer, an Internet session will continue to run to allow access to the server computer. The authorized external client can also restore the supervisor rights and manage the web server computer accordingly.

### CROSS REFERENCE TO RELATED APPLICATION

This application is a Continuation-in-Part of U.S. patent application Ser. No. 09/554,417 filed May 11, 2000 entitled System and Method of Securing a Computer From Unauthorized Access.

### FIELD OF THE INVENTION

The present invention relates generally to computer security and more specifically to making a computer impervious to unwanted users and methods thereof.

### BACKGROUND OF THE INVENTION

In order to maintain a computer server on the Internet, the server generally needs to be secured so that unwanted users will not break into sensitive areas on the server, particularly if the server is being used as an e-commerce server. One way to protect the server is to screen incoming requests with a firewall.

A firewall is a set of related programs, located at a network gateway server that protects the resources of a private network from users from other networks. An enterprise with an intranet that allows its workers access to the wider Internet installs a firewall to prevent outsiders from accessing its own private data resources and for controlling what outside resources its own users have access to.

Basically, a firewall filters all network packets to determine whether to forward them toward their destination. A firewall also includes or works with a proxy server that makes network requests on behalf of workstation users. A firewall is often installed in a specially designated computer separate from the rest of the network so that no incoming request can get directly at private network resources. However, a firewall is generally not impervious to unwanted users.

Since a firewall screens requests, the amount of traffic entering the server slows down considerably. Firewalls can be very complex and expensive, and often require an experienced technician to install and maintain. Furthermore, firewalls are open to attack from hackers, and once penetrated a hacker can gain supervisory rights to the server and access sensitive areas.

Thus, it would be desirable to provide a system and method of securing a computer that does not slow down traffic to the server, is easy to install, easy to use, inexpensive, and impervious to attack by unwanted users.

In the prior art, applicant is aware of U.S. Publication No. 2001/0039622 Published on Nov. 8, 2001 to Hitz et al. (“Hitz”), U.S. Pat. No. 6,434,619 issued on Aug. 13, 2002 to Lim et al. (“Lim”), U.S. Pat. No. 5,347,578 issued Sep. 13, 1994 to Duxbury (“Duxbury”), U.S. Pat. No. 5,822,435 issued Oct. 13, 1998 to Boebert et al. (“Boebert”), and U.S. Pat. No. 6,151,609 issued Nov. 21, 2000 to Truong (“Truong”).

Hitz is concerned with access to files and access to specific files is determined by user authentication. Lim specifically refers to the login to the specific server. In the present invention, one object is to restrict all access to the server and to use only as a service. Lim specifically teaches a methodology for managing a server from an alternate location using a secondary server or service. The present invention restricts all access to the server which is opposite to the objective of Lim.

Duxbury teaches a system wherein a user physically logs into a server. It is a user role monitoring system. One of the features of the monitoring program is the ability for a normal user to be granted supervisor user rights and then using a special shell script on the server has the supervisor user rights removed on exit. In the present invention, there are no users that log on to the server. Rather, the supervisor user is removed and no other users are available to take the place of the supervisor user on a temporary basis.

Boebert is concerned with the transport of data between a client and a server and is utilized very much like SSL. However, the present invention deals with the security of the server. In the present invention the user does not need to login to the server computer in order to lock and/or unlock the server. Indeed, it is not possible to login to the server in the present invention whether the line is secure or unsecure.

Truong is really only a different type of FTP. Truong does not edit the data files on the server, rather Truong moves the files to the client, edits the files and transports them back whereas in the present invention the files are manipulated and placed on the server. In the present invention the client can maintain an FTP session for the purpose of transporting files between the client and the server.

### SUMMARY OF THE INVENTION

The present invention provides a system and method of securing a server computer from unauthorized access without requiring a firewall. The server computer is secured from an external client computer over the Internet or a network by removing the server's root or supervisor user from the system. At the same time all other users are disabled by removing them or scrambling the password in such a manner that someone cannot log in to the server in the traditional manner. The external client computer can be authorized through a trusted IP address list, as well as requiring a password key from the user of the external client computer. A telnet session and an ftp session can remain connected between the server computer and the Internet in order to manage the server computer while it is locked even though there is no root access enabled. Even though the supervisor has been removed from the server computer, an Internet session will continue to run to allow access to the server computer. Telnet and FTP applications are examples of how the supervisor can perform work even after the server is “locked”, even though those services cannot be initiated once the server is locked. In the process of locking the server, all user accounts that are on the system are given “nonsense” passwords, so that it is not possible to login to these accounts. The authorized external client can also restore the supervisor user and manage the web server computer accordingly.

### BRIEF DESCRIPTION OF THE DRAWINGS

The present invention may be better understood, and its numerous objects, features, and advantages made apparent to those skilled in the art by referencing the accompanying illustrations. For simplicity and ease of understanding, common numbering of elements is employed where an element is the same in different illustrations.

FIG. 1 is a schematic diagram illustrating a client requesting access to a secure server over the Internet, in accordance with the present invention;

FIG. 2 is a block diagram of the secure server computer shown in FIG. 1, in accordance with the present invention;

FIG. 3 is a block diagram of one embodiment of the non-volatile memory module located within the secure server computer of FIG. 2; and

FIG. 4 is a flowchart of a method illustrating how an administrator can manage and secure the server computer, according to the invention.

### DETAILED DESCRIPTION OF EMBODIMENTS OF THE INVENTION

The following is a detailed description of illustrative embodiments of the present invention. As these embodiments of the present invention are described with reference to the aforementioned illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

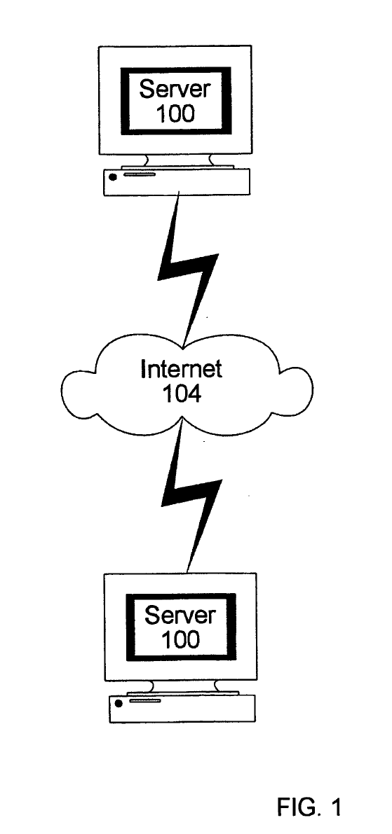

Referring now to FIG. 1, a schematic diagram illustrates a web server 100 and a client computer 102 connected to the Internet 104. Excellent results can be obtained when the web server 100 is running a Unix® operating system, however, other operating systems such as Windows® can also be used. A qualified user or an administrator using a client computer 102 has the ability to access the server 100 through the Internet 104 in order to manage the server 100 and to pseudo lock the server 100 so that no unauthorized access can be gained.

FIG. 2 is a block diagram of the web server computer 100 shown in FIG. 1. Computer 100 includes a CPU 202, RAM 204, non-volatile memory 206, an input device 208, a display 210, and an Internet interface 212 for providing access to the Internet.

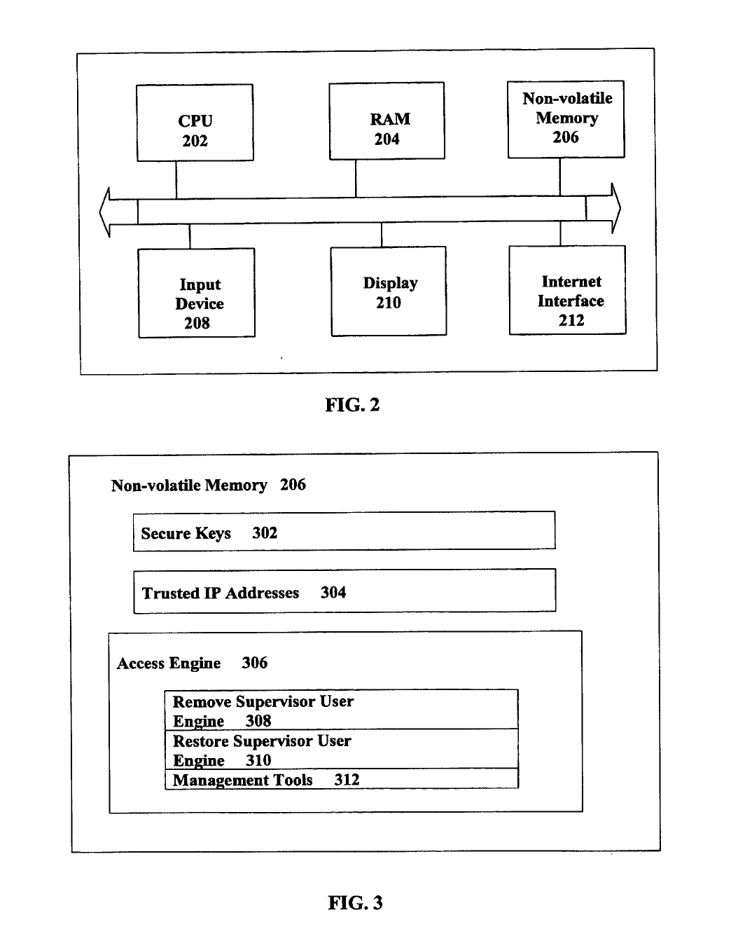

FIG. 3 is a block diagram of one embodiment of the non-volatile memory module 206 located within the web server computer 100 of FIG. 2. The non-volatile memory 206 includes a database of secure keys 302, a listing of trusted IP addresses 304, and an access engine 306. The database of secure keys 302 includes at least one authorized key or password that is known or held by the server administrator. The access engine 306 provides the administrator with various features for managing the web server computer 100, these features include: a remove supervisor user engine 308, a restore supervisor user engine 310, and management tools 312.

During the initial installation of the access engine 306 a password or a secure key 302 is established by the server administrator. The access engine 306 is programmed so that it is only accessible from an external client computer having a trusted IP address. The administrator is able to specify IP addresses that would allow access to the access engine 306.

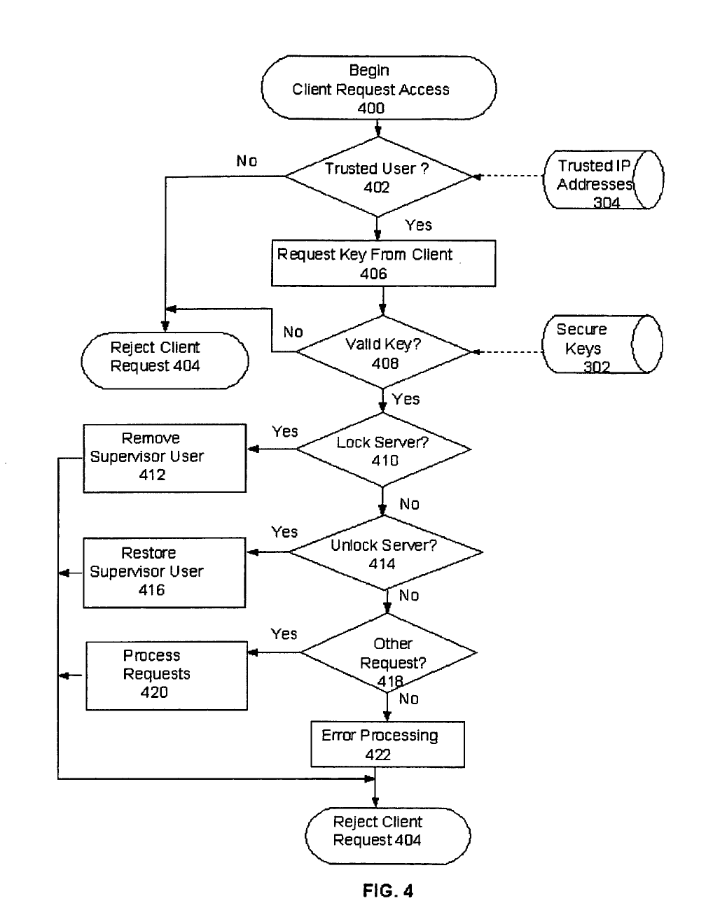

FIG. 4 is a flowchart of a method illustrating how to secure and manage the web server computer from an authorized client computer through the Internet in accordance with the invention. The administrator begins his request for access to the web server computer from a client computer at step 400 by starting the access engine. Next at step 402 it is determined if the request from the client computer is from a trusted IP address. The web server computer checks to see if the IP address of the requesting client computer is in the list of trusted IP addresses 304.

If the IP address of the requesting client is not in the list of trusted IP addresses 304 then at step 404 the client request to manage the web server computer is rejected. If the IP address of the requesting client is found in the listing of trusted IP addresses 304, then at step 406 a key or password is requested from the client. It is possible for computer hackers to “spoof” an IP address from an untrusted IP address, therefore an additional security measure of requiring a password is provided for a higher level of security.

If the password entered from the client is not in the database of secure keys 302 then at step 404 the client request to manage the web server computer is rejected. If the key entered from the client is in the database of secure keys 302, then the requesting client is authorized to manage the web server computer.

After being authorized to manage the web server computer, at step 410 the administrator decides whether to lock the server. If the administrator decides to lock the server then at step 412 supervisor user on the web server computer are then physically removed thereby locking the server computer from any unauthorized access, and at step 424 the process ends. Prior to removing the supervisor user on the web server, a telnet session and an ftp session are established with the web server so that the web server can still be accessed over the Internet by, and only by, the client 102.

In order to lock the server, the root, or alias root, is physically removed from the server. This requires rewriting the password file without any supervisory rights in it. In a UNIX operating system, in order to physically remove the root or the supervisory rights from the server, the User ID=0 (UID=0) and the Group ID=0 (GID=0) are removed from the computer's user list and group list. After the root is removed, the web server computer is functionally dead or secure and no supervisory commands can be issued at the console of the web server, but the telnet session and the ftp session stay connected and allow the trusted client to access the server over the Internet. Even though the server is functionally dead and nobody can access the server as a supervisor, other applications on the web server continue to run and allow access from users on the Internet.

If, at step 410, the administrator does not lock the server, then at step 414 the administrator has the option to unlock the web server if the server has been previously locked. However, physical login to the server by any user is not allowed while the server is locked, because there are no valid passwords maintained on the system. If the administrator chooses to unlock the server then at step 416 supervisor user on the server are restored, and at step 424 the process ends. In order to restore the supervisor user, the supervisor is added to the user list and the group list (i.e. UID=0 and GID=0 is added).

If, at step 414, the server is not unlocked, then at step 418 the administrator can choose to process other requests, such as managing the files on the server. At step 420 any requests by the administrator from the trusted client are processed, and at step 424 the process then ends. If no requests are made by the administrator, then at step 422 the access engine goes through error processing and at step 424 the process ends.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A system for securing a server computer from unauthorized access, comprising:
an access engine for removing the supervisor user on the server computer.

2. The system of claim 1, wherein removing the supervisor user includes removing a root from the server.

3. The system of claim 1, wherein the access engine allows access to the servce from an external client computer so as to remove the supervisor user.

4. The system of claim 3, wherein the access engine allows the supervisor user to be restored on the server computer from an external client computer.

5. The system of claim 3, further including a list of trusted IP addresses, wherein the external client computer can only remove the supervisor user on the server computer if the external client computer has an IP address in the list of trusted IP addresses.

6. The system of claim 5, further including a password key, wherein the external client computer can only remove the supervisor user on the server computer if the password key is provided by a user of the external client computer.

7. The system of claim 1, wherein the server computer is a world-wide-web server computer connected to an Internet.

8. A method of securing a server computer from unauthorized access, comprising the steps of:
removing the supervisor user on the server computer; and
allowing external access to applications on the server computer.

9. The method of claim 8, further including the steps of:
providing a list of trusted IP addresses; and
authorizing an external client computer to remove the supervisor user only if the external client computer has an IP address in the list of trusted IP addresses.

10. The method of claim 9, further including the steps of:
providing a password key; and
authorizing the external client computer to remove the supervisor user only if the password key is provided by a user of the external client computer.

11. The method of claim 8, wherein removing supervisor user includes removing a root from the server computer.

12. The method of claim 8, wherein removing the supervisor user is done from an external client computer over an internet.

13. A computer-readable medium comprising program instructions for securing a server computer from unauthorized access, by performing the steps of:
removing the supervisor user on the server computer from an external client computer; and
allowing external access to applications on the server computer.

14. The computer-readable medium of claim 13, further performing the steps of:
providing a list of trusted IP addresses; and
authorizing the external client computer to remove the supervisor user only if the external client computer has an IP address in the list of trusted IP addresses.

15. The computer-readable medium of claim 14, further performing the steps of:
providing a password key; and
authorizing the external client computer to remove the supervisor user only if the password key is provided by a user of the external client computer.

16. The computer-readable medium of claim 13, wherein removing the supervisor user includes removing a root from the server computer.

17. A system for securing a server computer from unauthorized access by a user, comprising:
an access engine for temporarily and replaceably removing the supervisor user on the server computer so as to temporarily lock the server computer and to thereby prevent physical login to the server computer by any user while the server computer is so locked.

18. The system of claim 17, wherein removing the supervisor user includes removing a root from the server.

19. The system of claim 17, wherein the access engine allows removing the supervisor user from an external client computer.

20. The system of claim 19, wherein the access engine allows the supervisor user to be restored on the server computer from an external client computer.

21. The system of claim 19, further including a list of trusted IP addresses, wherein the external client computer can only remove the supervisor user on the server computer if the external client computer has an IP address in the list of trusted IP addresses.

22. The system of claim 21, further including a password key, wherein the external client computer can only remove the supervisor user on the server computer if the password key is provided by a user of the external client computer.

23. The system of claim 17, wherein the server computer is a world-wide-web server computer connected to an Internet.

24. A method of securing a server computer from unauthorized access by any user, comprising the steps of:
temporarily and replaceably removing the supervisor user on the server computer so as to temporarily lock the server computer and to thereby prevent physical login to the server computer by any user while the server computer is so locked; and
allowing external access to applications on the server computer.

25. The method of claim 24, further including the steps of:
providing a list of trusted IP addresses; and
authorizing an external client computer to remove the supervisor user only if the external client computer has an IP address in the list of trusted IP addresses.

26. The method of claim 25, further including the steps of:
providing a password key; and
authorizing the external client computer to remove the supervisor user only if the password key is provided by a user of the external client computer.

27. The method of claim 24, wherein removing the supervisor user includes removing a root from the server computer.

28. The method of claim 24, wherein removing the supervisor user can be done from an external client computer over an internet.

29. A computer-readable medium comprising program instructions for securing a server computer from unauthorized access by any user, by performing the steps of:
temporarily and replaceably removing the supervisor user on the server computer from an external client computer so as to temporarily lock the server computer and to thereby prevent physical login to the server computer by any user while the server computer is so locked; and
allowing external access to applications on the server computer.

30. The computer-readable medium of claim 29, further performing the steps of:
providing a list of trusted IP addresses; and
authorizing the external client computer to remove the supervisor user only if the external client computer has an IP address in the list of trusted IP addresses.

31. The computer-readable medium of claim 30, further performing the steps of:
providing a password key; and
authorizing the external client computer to remove the supervisor user only if the password key is provided by a user of the external client computer.

32. The computer-readable medium of claim 29, wherein removing the supervisor user includes removing a root from the server computer.
